(19) United States
(12) Patent Application Publication
(10) Pub. No.: US 2009/0300958 A1
(43) Pub. Date: Dec. 10, 2009

(54) Cake decorating memento

(76) Inventor: Robin Lousie Aguiar, Fremont, CA (US)

Correspondence Address: Aldo DeAmicis, 35549 Linda Dr., Fremont, CA, 94536, US

(21) Appl. No.: 12/157,230

(22) Filed: Jun. 9, 2008

(51) Int. Cl. G09F 3/18

(52) U.S. Cl. 40/642.02

(57) ABSTRACT

Disclosed is a cake decorating memento which can be reused or saved as a keepsake. The device enhances the atmosphere of a celebration event such as but not limited to an anniversary, birthday or graduation. The cake decorating device displays a congratulation message and or picture at the top of the device. The decorative base of the device can either be a miniature ladder or stairs coupled with a display board showing a message and or picture. This device will increase the celebratory event by representing a passage of a life event with the satisfaction of reaching a goal at the end of the journey.

### FIELD OF THE INVENTION

The present invention relates to a cake decorating device and, more particularly, to a cake decorating memento for use in adding ambiance to numerous celebratory occasions such as, anniversaries, birthdays or a similar significant day in which the device shows an inspirational message and or picture and can be saved as a keepsake.

### BACKGROUND OF THE INVENTION

As world economies expand and individuals enjoy general development of their own microeconomics, society shows the need for celebrating life events. This takes place in the form of various celebratory events which often use the cake as a means of communicating the theme of the event. Creating a festive atmosphere is currently captured by using candles or by having a written messages on the cake. These uses are well know and provide a limited increase to a festive atmosphere. The need remains to have a unique cake decorating device that provides the theme of obtaining a challenging life goal with a message and or picture that echoes that achievement.

Other ideas have used ornaments added on a cake as a decorative devices in limited fashion. Most have focused on using an array of candles coupled with some other ornament to convey a message. None have used a decorative ladder or stairs coupled with a communication holder. The ladder or stairs being a critical component by representing an arduous, symbolic life journey or goal such as a graduation, 50th anniversary or birthday.

U.S. Pat. No. 5,673,802 to Vaentino shows a rotatable candle holder that get placed on top of a cake with a plurality of candle extending radially out from a platform with a center candle in the middle in the shape of a number or other candle shapes. This patent shows a device for holding an array of candles but lacks a ladder or stairs combined with a message or picture holder.

U.S. Pat. No. D403,441 to Lane shows a design for a cake and candle holder with the message of “Happy Birthday” on the cake platter. This patent only shows a “Happy Birthday” message and does not incorporate the ladder, stairs or interchangeable picture or message holder.

U.S. 2006/0048652 A1 published application to Heon-Sang Ahn shows a cake decorating device, characterized by a congratulation message displayed on thermal sensitive paper activated by the heat of the candles when lit. This published application shows a congratulation message but does not accommodate the use of a picture nor does not make use of a symbolic cake decorating device as a ladder or set of stairs.

It is a primary object of the present invention to provide a cake decorating device that uses either a miniature decorative ladder or stairs as a base with a message or picture or combination of the two, mounted vertically on top of the base.

It is another object of the present invention to preserve the memory of the occasion by making the device attractive to be saved as a keepsake.

It would further be advantageous of the present invention to have the ability to be reused with capability to change messages or pictures depending on the occasion to be celebrated

### SUMMARY OF THE INVENTION

In accordance with the present invention, there is provided a cake decorating device that can either be reused or saved as a memento. The device is placed on top of the cake to enhance the celebratory nature of an event such as but not limited to a birthday, anniversary or graduation. The device has two main components having a decorative base which is attached to a display board. The decorative base can either be a miniature extended step ladder or a set of miniature stairs representing an upward life journey. The display board can either be exchangeable with a message, picture or combination thereof.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a left perspective view of a cake decorating device memento in accordance with the invention;

FIG. 2 is a right perspective view of an another embodiments of the invention;

FIG. 3 is a right perspective view of an of another embodiments of the invention;

FIG. 4 is a front perspective view of an of another embodiments of the invention; and

FIG. 5 is a right perspective view of an of FIG. 4 showing another embodiment of the invention.

For purposes of clarity and brevity, like elements and components will bear the same designations and numbering throughout the Figures.

### DESCRIPTION OF THE PREFERRED EMBODIMENT

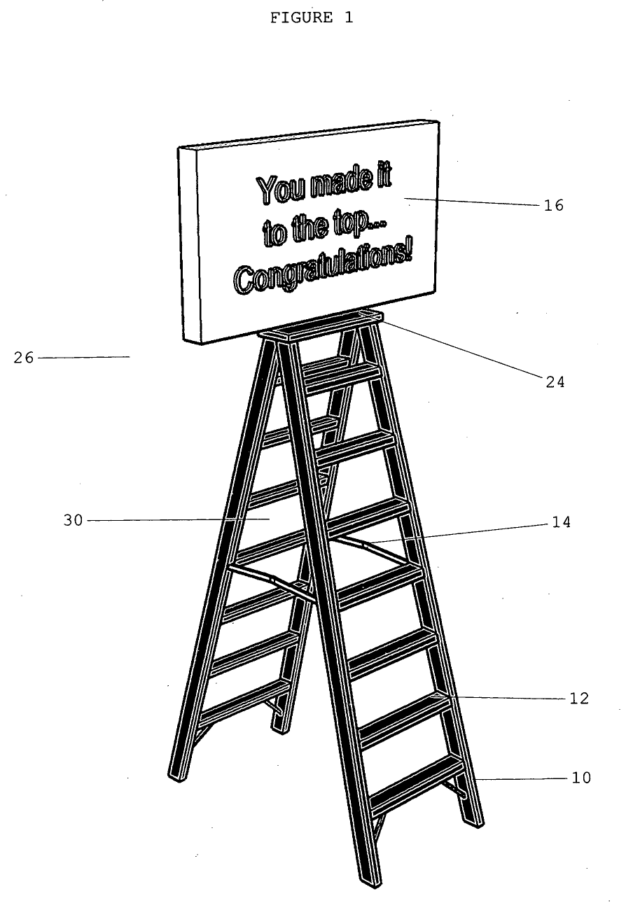

FIG. 1 is left perspective view of a cake decorating memento 26, in accordance with the invention. A Climbing base 30 commonly known as a ladder is represented by elements including upright ladder members 10, rungs 12, and stays 14, The climbing base 30 can take the miniature appearance of a common step ladder found at homedepot.com, Husky model number 01-46001-02 or any other commercially available ladder. The ladder can have more or less component parts associated with ladder construction and encompasses all configurations of ladders or combination of shapes and sizes. The climbing base 30 in the cake decorating memento 26 can be fabricated of wood, plastic, metal or any other suitable material. A mounting surface 24 on top of the climbing base 30 is fastened by any method with the display board 16 which portrays the celebratory event by using statements and or pictures.

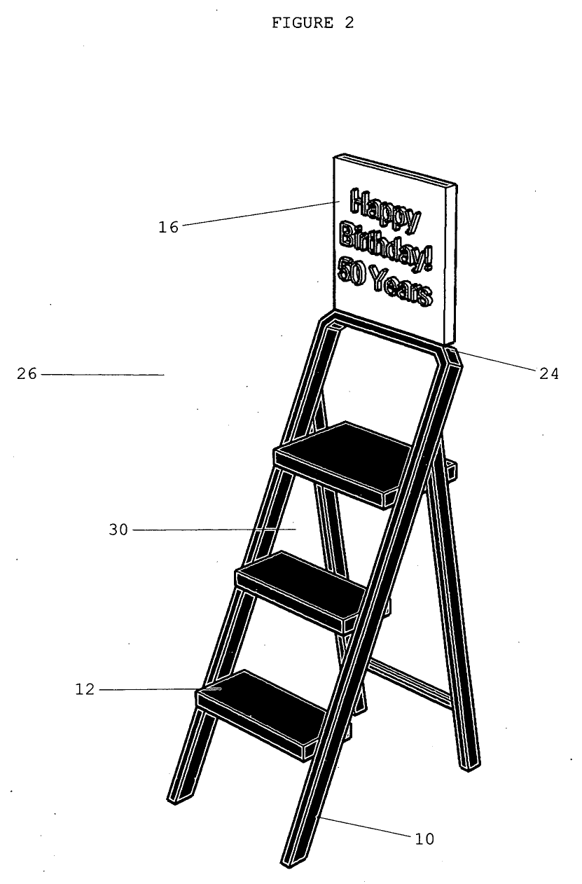

FIG. 2 is right perspective view of another embodiment of a cake decorating memento 26, in accordance with the invention. A Climbing base 30 commonly known as a ladder is represented by elements including upright ladder members 10, rungs 12, and stays 14. The climbing base 30 can take the miniature appearance of a common step ladder found at homedepot.com, Gorilla Ladders model number ASL2-4 or any other commercially available ladder. The climbing base 30 in the cake decorating memento 26 can be fabricated of wood, plastic, metal or any other suitable material. A mounting surface 24 on top of the climbing base 30 is fastened to the display board 16 by any method. The objective the embodiment portraying a life journey up a symbolic climbing base 30 showing a statements and or pictures. The cake decorating memento 26 is placed on top of the cake.

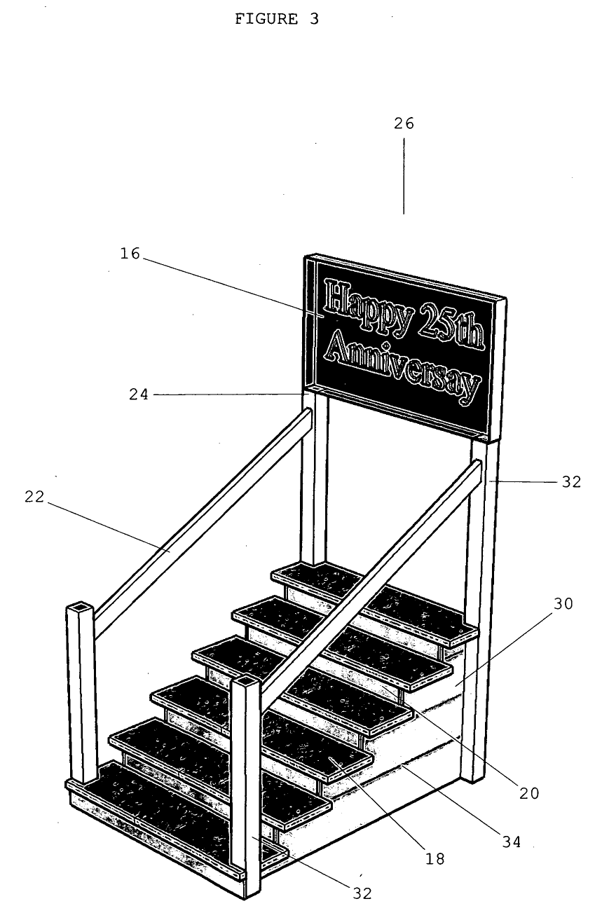

FIG. 3 is a right perspective view of the cake decorating memento 26 in accordance with the invention. A climbing base 30 commonly known as stairs is represented by elements including treads 18, risers 20, hand rails 22, upright stair members 32 and stringers 34 known to be components of generic stair construction. Any configuration of stairs can be used to represent the symbolism of going up the climbing base 30 to reach a life goal or objective. The stairs can have more or less component parts associated with stair construction and encompasses all configurations of stairs or combination of shapes and sizes. The miniature climbing base 30 can be constructed of wood, plastic, metal or any other suitable material. A mounting surface 24 on top of the climbing base 30 is fastened to the display board 16 by any method.

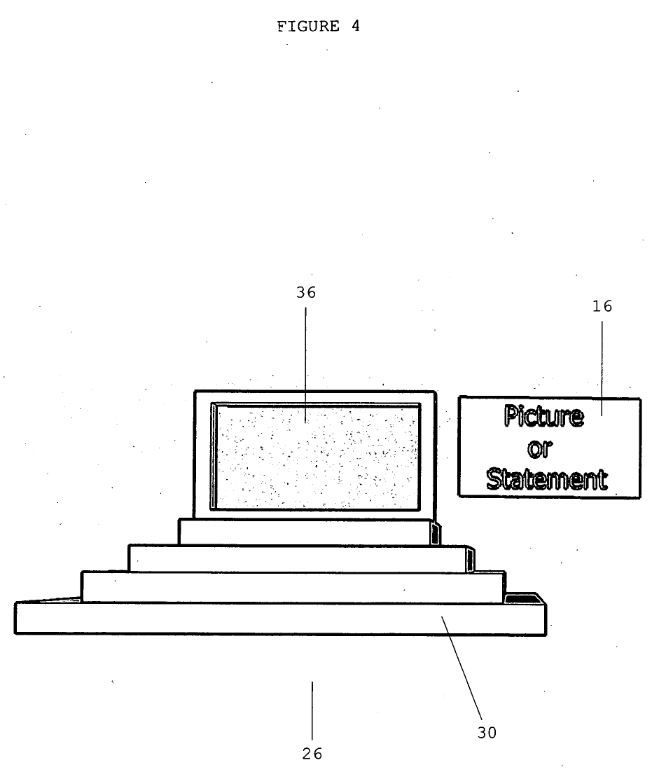

FIG. 4 is a front perspective view of another embodiment of a cake decorating memento 26 in accordance with the invention. A climbing base 30 commonly known as stairs is represented. The miniature climbing base 30 can be made of wood, plastic, metal or any other suitable material. A mounting surface 24 on top of the climbing base 30 is fastened to the communication holder 36 by any method. The display board 16 showing statements and or pictures can be mounted into the communication holder 36 by sliding the display board 16 into the slotted opening of the communication holder 36. Once the display board 16 is placed inside the communication holder 36 the cake decorating memento 26 is placed on top of the cake.

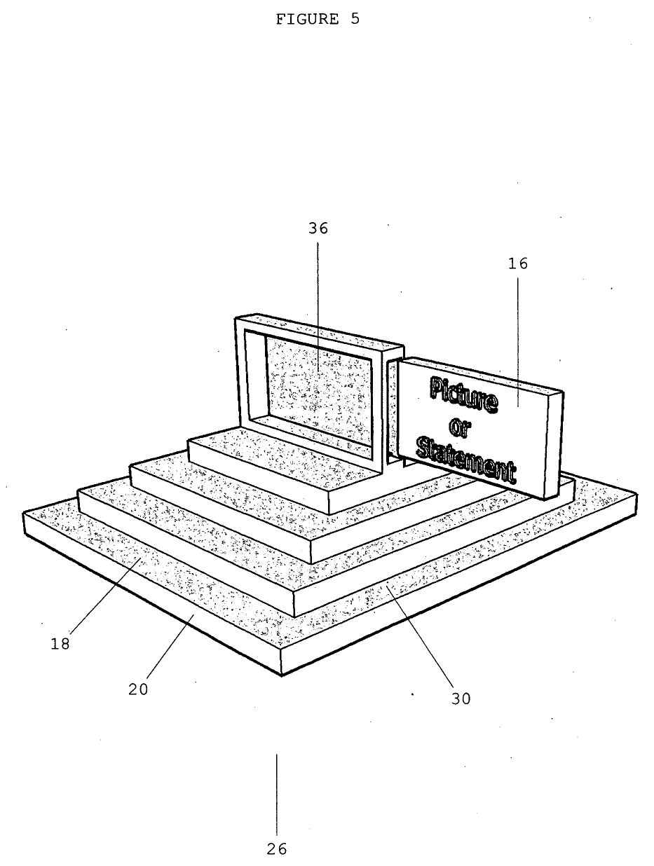

FIG. 5 is a right perspective view of FIG. 4 a cake decorating memento 26 in accordance with the invention. This embodiment uses treads 18, and risers 20 to accomplish the effect of the symbolic miniature climbing base 30. The slotted opening of the communication holder 36 can be seen more effectively in this perspective and is used to receive the display board 16.

In summary, it can be seen that what is provided in this invention is a cake decorating memento 26 that is both functional and decorative. A ladder or stair shaped miniature climbing base 30 is attached to a communication holder 36 by a mounting surface 24. The communication holder 36 has a removable display board 16 which makes it reusable for other occasions. The construction and look of the cake decorating memento 26 is such as it would be likely be saved as a keepsake.

Since other modifications and changes varied to fit particular operating requirements and environments will be apparent to those skilled in the art, the invention is not considered limited to the example chosen for purposes of disclosure, and covets all changes and modifications which do not constitute departures from the true spirit and scope of this invention.

Having thus described the invention, what is desired to be protected by Letters patent is presented in the subsequently appended claims.

What is claimed is:

1. A cake decorating memento, comprising:
means for displaying a message, picture or combination thereof;
means for symbolism using a miniature ladder or stairs; and
means for holding said display board, fully encompassing said means for displaying a message, picture or combination thereof.

2. The cake decorating memento in accordance with claim 1, wherein said means for displaying a message, picture or combination thereof comprises a display board. Said display board can be manufactured with messages, pictures or combination thereof or individualized messages or pictures can and attached to a blank said display board.

3. The cake decorating memento in accordance with claim 1, wherein said means for symbolism using a miniature ladder or stairs comprises a climbing base. Said ladder can have more or less component parts associated with ladder construction and encompasses all configurations of ladders or combination of shapes and sizes. Said stairs can have more or less component parts associated with stair construction and encompasses all configurations of stairs or combination of shapes and sizes.

4. The cake decorating memento in accordance with claim 1, wherein said means for holding said display board comprises a communication holder. Said communication holder comprises a slotted opening to receive the display board.

5. A cake decorating memento, comprising:
a display board, for displaying a message, picture or combination thereof;
a climbing base, for symbolism using a miniature ladder or stairs; and
a communication holder, for holding said display board, enclosing said display board.

6. The cake decorating memento as recited in claim 5, further comprising:
a mounting surface, for securing the display board sign, securely fastened to said climbing base, and rigidly connected to said communication holder.

7. The cake decorating memento as recited in claim 5,
wherein the communication holder comprises a slotted opening to receive the display board.
